(19) United States
(12) Patent Application Publication
(10) Pub. No.: US 2014/0228169 A1
(43) Pub. Date: Aug. 14, 2014

(54) ELECTRIC DRIVE SYSTEM FOR A BATTERY-POWERED LIGHT VEHICLE

(71) Applicants: Heinz Leiber, Oberriexingen (DE); Thomas Leiber, Muenchen (DE); Jochen Keller, Muenchen (DE)

(72) Inventors: Heinz Leiber, Oberriexingen (DE); Thomas Leiber, Muenchen (DE); Jochen Keller, Muenchen (DE)

(73) Assignee: CPM COMPACT POWER MOTORS GmbH, Unterfoehring (DE)

(21) Appl. No.: 14/342,614

(22) PCT Filed: Aug. 30, 2012
(86) PCT No.: PCT/EP2012/066892

§ 371 Date: Apr. 10, 2014

(30) Foreign Application Priority Data
Sep. 2, 2011 (DE) 10 2011 112 091.6

(51) Int. Cl. B60W 10/11; B60W 10/08

(52) U.S. Cl. CPC B60W 10/11; B60W 10/08
USPC 477/15

(57) ABSTRACT

The invention relates to an electric drive system for a battery-powered light vehicle, comprising at least one drive motor, a transmission driven by the drive motor for selecting at least two gears, and an actuator for shifting the transmission into the shifting positions, characterized in that an automated transmission, in particular having a freewheel mechanism, is provided.

The present invention relates to an electric drive system according to the preamble of claim 1.

### PRIOR ART

Small battery-powered electric vehicles require a high overall efficiency in order to achieve the widest possible range.

Electric wheel hub motors are known in bicycles or electric scooters. Wheel hub motors increase the unsprung mass and are therefore often undesired in electric scooters. For this reason, central motors with a belt or chain gearing on the rear wheel are used to an increasing extent and these are combined with a planetary gear train or worm gear, if required. Geared motors with internal rotor motors and internal transmissions as the rear wheel drive are also known.

Drive systems for two-wheeled vehicles driven by internal combustion engines usually have a CVT transmission (variomatic principle). This allows a wide ratio range, so that an acceptable acceleration behaviour can even be realised for low torques of the internal combustion engine. These CVT transmissions have a poor efficiency and are therefore not suitable for battery-powered electric vehicles, because the system costs rise significantly due to the storage of a relatively great battery capacity.

To increase the efficiency or the acceleration behaviour, manually shiftable transmissions are also used to some extent.

### OBJECT OF THE INVENTION

The object of the invention is to provide a compact and cost-effective drive system which has a high efficiency and satisfies the requirements of the driving behaviour of a two-wheeled vehicle.

### ACHIEVEMENT OF THE OBJECT

The object of the invention is achieved by the features of claim 1.

In other words, the object according to the invention is achieved by the combination of a highly efficient electric motor with an automated efficient two-speed or three-speed transmission. In this drive system, the gear-shift procedure can take place without a coupling and the gears can be shifted by a simple cost-effective shift actuator. The synchronisation via the electric motor takes place so quickly that the interruption in torque is virtually unnoticeable.

Further embodiments and configurations of the invention and the advantages thereof are contained in the further claims.

The drive system is advantageously configured such that a recuperation of braking energy is possible and so is, at the same time, a coasting mode, i.e. the vehicle moves while the drive is disengaged. The latter is desirable in the case of two-wheeled vehicles, particularly when the vehicle is being pushed.

An important feature of the drive system is the cooling of the electric motor by the gear oil which is expediently allowed in that the motor and the transmission form an integrated unit and sit in one housing.

Furthermore, the transmission is configured such that three gears can be actuated by one shift actuator and one shift sleeve, whereas conventional transmissions of two-wheeled vehicles have up to three shift sleeves.

The transmission also comprises a very advantageous shift actuator which is activated only in a controlled manner (without a sensor) and allows three shift positions and can be controlled by a simple electronic circuit via PWM.

The drive according to the invention and the configurations thereof have the following advantages over alternative drive systems:
compact construction
low weight
high efficiency in driving mode (displacement into the optimum point of the motor)
high acceleration and climbing power
more cost-efficient compared to a larger motor
cost-effective shift actuator
lower thermal load

### DESCRIPTION OF THE FIGURES

Embodiments of the invention and the configurations thereof are described in more detail in the following description of the figures with reference to the drawings in which:

FIG. 1 shows the structure of a two-speed transmission with a linear shift actuator;

FIG. 2 shows a further embodiment of a two-speed transmission with an outwardly displaced linear shift actuator;

FIG. 2a shows a configuration basically according to FIG. 2 with low vertical forces;

FIG. 2b shows a drive unit with a two-stage gear ratio to the wheel;

FIG. 2c shows an alternative configuration;

FIG. 2d shows an embodiment with two motors;

FIG. 3 shows the time course of a gear-shift procedure during acceleration;

FIG. 4 shows the force characteristic map of the adjusting actuator;

FIG. 5 is a schematic diagram of a three-speed transmission; and

FIG. 6 is a schematic diagram of a two-speed transmission.

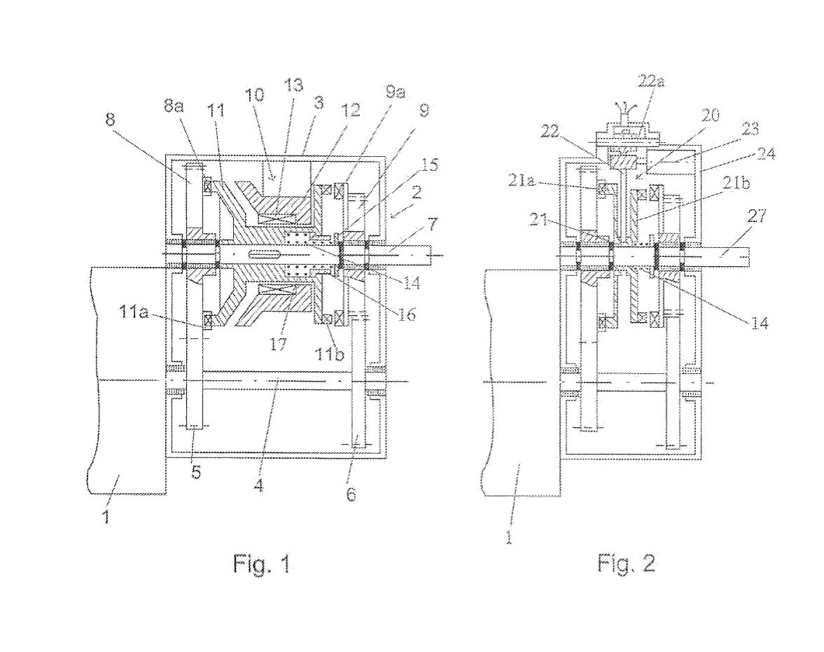

The first embodiment shown in FIG. 1 is of an electric motor 1 with a two-speed transmission 2 which is arranged in a transmission housing 3. A drive shaft 4 having two gear wheels 5, 6 arranged in a non-rotatable manner thereon leads from the motor 1 into the transmission housing. Two further gear wheels 8, 9 are mounted rotatably on a second shaft 7 arranged in the transmission housing. Toothed rings 8a, 9a are attached to these gear wheels 8, 9. A linear actuator 10 is arranged between the gear wheels 8, 9. The linear actuator 10 has substantially one shift sleeve 11 which is arranged in a non-rotatable and axially displaceable manner on the shaft 7 and has a first toothed ring 11a which cooperates with the toothed ring 8a in an appropriate gear-shift position and has a second toothed ring 11b which cooperates with the toothed ring 9a in an appropriate gear-shift position. An actuating device 12 is arranged, fixed to the housing, between the toothed rings 11a, 11b and it has a magnetic means 13 which can be actuated by an electronic means (not shown here) in order to move the shift sleeve 11 axially out of the first gear-shift position shown in FIG. 1 via a second neutral gear-shift position into a third gear-shift position. In the first gear-shift position, the gear wheels 5 and 8 are operative. This shift position is adopted when the magnetic means is not actuated, since a spring 14 which is supported on the shaft 7 or on a disc 15 connected to the shaft, acts axially against the shift sleeve 11 to press it into this shift position. By actuating the magnetic means, the shift sleeve can be moved to the right in the drawing against the force of the spring 14. After a particular distance, a step sleeve 16, arranged axially displaceably in the shift sleeve 11, meets the disc 15. As a result, a further spring 17 is activated which is arranged in particular concentrically to the first spring 14 and is supported on one side against the shift sleeve 11 and on the other side against the step sleeve 16. Due to the effective force of the additional spring 17, the effective magnetic force cannot move the shift sleeve further, so that the shift sleeve arrives in a neutral intermediate position with this magnetic force and remains there until the magnetic force is increased by increasing the current and the shift sleeve can then also overcome the force of the additional spring 17 in order to arrive in a further shift position in which the coupling wheels 6 and 9 are engaged.

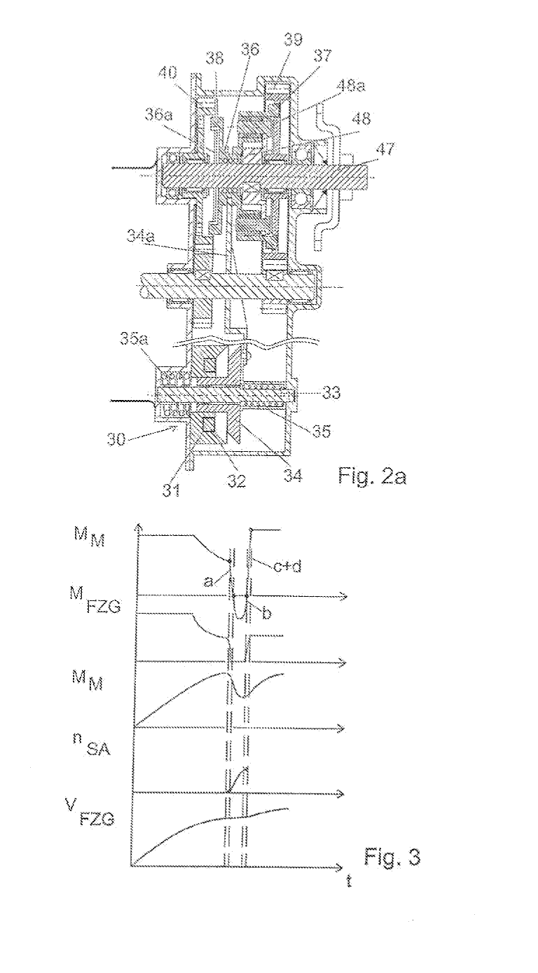

FIG. 2 shows an embodiment of a two-speed transmission which is more compact axially. This is achieved by arranging the linear actuator 20 substantially radially outside the gear wheels. In this figure, the linear actuator 20 has a catch 22 which is arranged in an axially displaceable manner on a guide means, in particular on a guide bolt 22a and which engages in a shift sleeve 21 which sits in an axially displaceable manner on the shaft 27 and supports two toothed rings 21a, 22a which cooperate with the corresponding gear wheels. For the linear displacement of the catch 22, said catch sits in an axially displaceable manner on a guide element. An actuatable magnetic means 23 is arranged in the transmission housing 23. The catch can be moved axially by this magnetic means 23 against the force of a spring 14 out of the (illustrated) first shift position via a neutral position into a further shift position in which the toothed ring 21b engages with the associated gear wheel. This procedure corresponds to that of FIG. 1.

FIG. 2a shows an embodiment which corresponds substantially to that of FIG. 2 in respect of the arrangement of the actuator, i.e. the linear actuator 30 is arranged radially outside the coupling wheels. In this figure, an actuating means 31 fixed to the housing has an actuatable magnetic means 32 to attract an actuator element 34, arranged in an axially displaceable manner on a shaft 33, against the force of a spring 35 and to thereby move it (in the figure, to the left). As a result, a catch or driver 34a connected to the actuator element 34 moves a shift sleeve 36 which sits in an axially displaceable manner on a gear shaft 47 and has toothed rings 37, 38, out of the (illustrated) first shift position via a neutral position into a further shift position in which the toothed ring 38 engages in the gear wheel 40. The shift sleeve 36 can be expediently arranged on a bearing bush 36a consisting of a material of a low friction coefficient to reduce the friction during the gear-shift procedure. In this figure as well, a neutral position is realised by a further spring 35a which becomes operative in addition to the force of the spring 35 after the actuator element 34 has travelled a particular distance. In this respect, the actuator element 34 acts, for example on a disc which is arranged between the actuator element and spring 35a. This embodiment makes it possible to realise particularly low adjusting forces. In this configuration, a driver 48 is provided which supports pins 48a with a radial distance from the shaft 47, which pins 48a engage in corresponding recesses in the toothed ring 37 via bearing bushes. This embodiment makes it possible to realise particularly low adjusting forces.

FIG. 2b illustrates a drive unit with a two-stage gear ratio to the driven wheel 60. A first stage is realised in the transmission and a second stage 65 is realised by, for example, a belt or a chain to the wheel 60. The structure of the transmission and the gearshift substantially correspond to those of FIGS. 2 and 2a, so that in this respect reference will be made thereto for the sake of simplicity.

The electric motor 51 has an external rotor 53 which drives the transmission via the motor shaft 54 and a connection 55 of the motor shaft with the gear shaft 56. Here, the transmission housing 58 is divided and, in an elongated section, also receives the electric motor. A housing 59 for accommodating the electronics is attached on the side, remote from the drive side, of the motor housing portion. During assembly, the motor is inserted into this portion and connected to the gear shaft by a connection (for example by a feather spring). The connection is configured in particular to be releasable so that the motor can be inserted as a module. The drive also has a means for cooling the motor. For this purpose, between the part of the housing receiving the transmission and the part receiving the motor is a partition wall 61 with passages 62, 63, so that it is possible to realise a circulation of gear oil.

FIG. 2c shows a configuration in which the motor 71 is again arranged in a region of the transmission housing 78. In this case, the motor or the region of the housing accommodating the motor is arranged offset or next to the part of the housing accommodating the transmission. The housing accommodating the electronics is also arranged in this region. The rotation of the motor shaft 74 is transferred in a first stage by a transmission which is arranged outside on the transmission housing and is covered by a housing cover 78a, for example. This transmission transfers the movement onto the input shaft of the gearshift. The output shaft of the gearshift goes directly to the driven wheel 60 or is transmitted once again by a chain or belt 79, for example. In this configuration as well, a cooling system is provided, as described with regard to FIG. 2b.

FIG. 2d schematically illustrates a configuration in which two adjacently arranged motors 101, 102 with the shafts of which 101a, 102a act on the input shaft 106 of the transmission via a pinion 103 and via, for example, a belt or chain 104 and a pinion 105. The motor 101 is provided with a free-wheel 109. The output shaft of the transmission is denoted by reference numeral 107. All these components are accommodated in a common housing 108. Alternatively, the two motors can also be connected by toothed wheels. This configuration allows a compact arrangement with a high power density. Furthermore, one motor can be disconnected to prevent drag losses in part load operation.

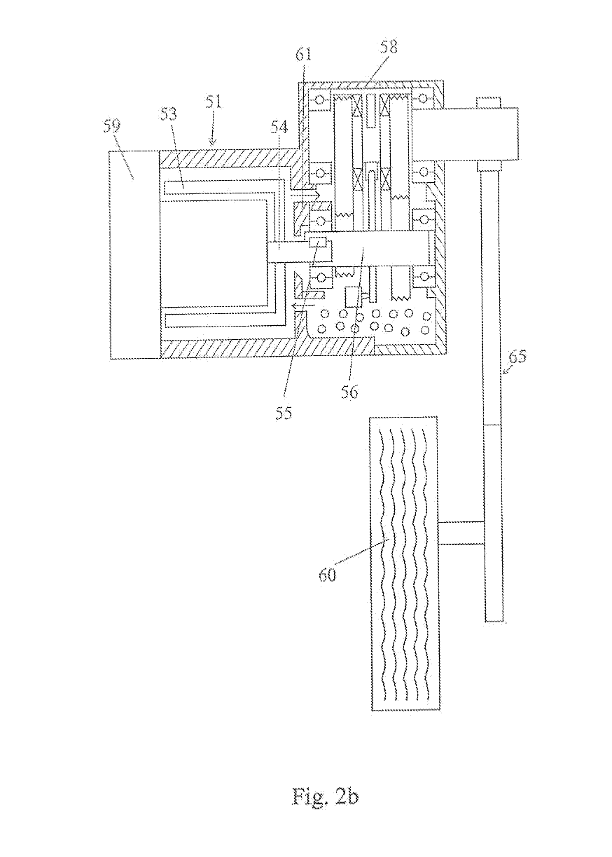

FIG. 3 shows the course of time of a gear-shift procedure during acceleration, where M_{M} means motor torque, M_{FZG} means moment on the wheel, n means motor speed, h_{SA} means stroke position of shift actuator and V_{FZG} means vehicle speed. The figure illustrates an acceleration procedure with full moment and thereafter reduction of the moment according to power criteria (usually predetermined by the battery). The gear-shift procedure is carried out in four steps:
(a) the motor is made moment-free for disengagement, i.e. M_{M}→0, n_{M}→constant, h_{SA}→no actuation (shown in the figure as branch a of the course M_{M});
(b) gear-shift procedure where: h_{SA}→actuator adjustment, at the same time, reduced to an appropriate speed, e.g. half speed reduced where i1/i2=0.5, M_{M} becomes negative to decelerate the motor (shown in the figure as branch b of course M_{M}) ;
(c) new position of actuator for engagement: M_{M}=0, n_{M}=half speed, h_{SA}=slight actuator movement for engagement (shown in the figure as branch c+d of the course M_{M});
(d) gear changed: M_{M}→double moment, h_{SA}→accelerates further.

Due to a gear-shift procedure of this type, no change in moment can be noticed on the wheel during the shift. In this respect, it is a crucial factor that there is a fast synchronisation of the motor speed and a fast shift procedure by activating the shift actuator so that changes in torque are unnoticeable. In the drawing, the course of time is shown as being relatively long. In reality, it can be less than 0.1 seconds. For this, a small drive motor with a low mass of inertia is particularly advantageous, which runs at high speeds and generates the power via the speed.

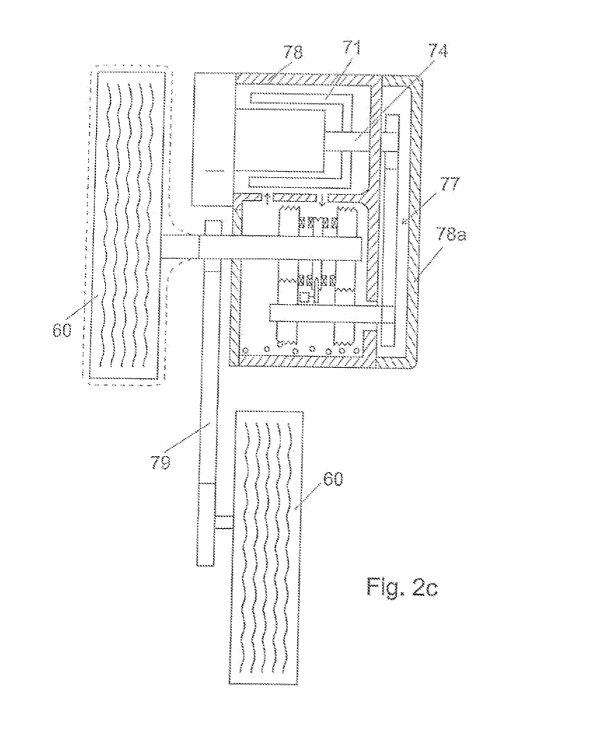

FIG. 4 shows the force characteristic map of the adjusting actuator. The figure illustrates the two-stage spring characteristic and the course of the magnetic force for different currents. As can be clearly seen from the course, a distinct and stable middle position is produced by a force surge KS and by the magnetic force/current connection, as described above in connection with FIG. 1.

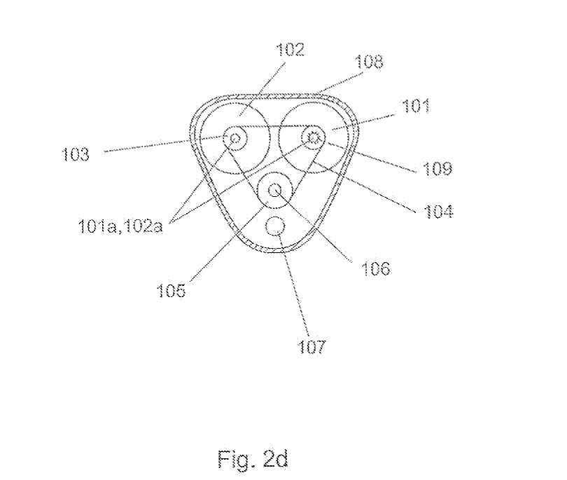

FIG. 5 schematically shows an enhancement to a three-speed transmission. The first speed is realised by the gear wheels 81 and 82, the second speed is realised by the gear wheels 83 and 84 and the third speed is realised by the gear wheels 85 and 86. The gear wheel 82 on the driven shaft is provided with a free-wheel 82a. An actuator 88 is arranged between the gear wheels 84 and 86. The actuator 88 can be constructed as previously described. As a result of the free-wheel, among other things the vehicle can be easily pushed in first gear, without entraining the motor.

In this transmission, when second gear is engaged, the free-wheel becomes operative when the speed of the driven shaft increases. The advantages of this configuration are that with only one actuator, a three-speed transmission can be realised, whereby in first gear, it is possible to push the vehicle, in second gear and third gear a recuperation can take place and a blocking of the motor has a relatively weak effect.

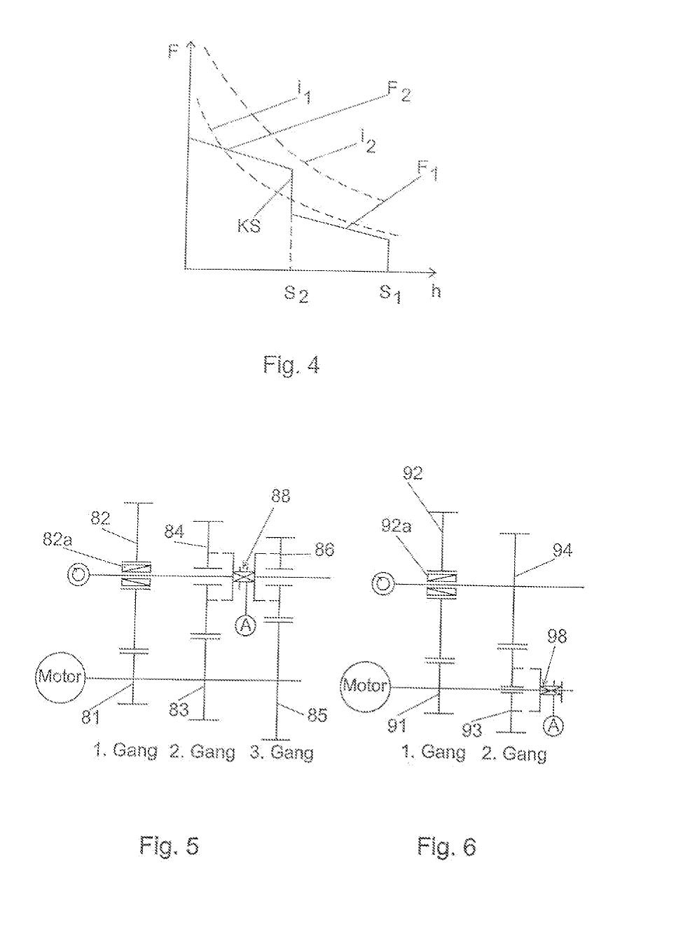

FIG. 6 shows a simplified gearshift with a motor, a drive shaft, a driven shaft, gear wheels 91, 92 for first gear, gear wheels 93, 94 for second gear and a shift actuator 98. A free-wheel 92a is provided on the gear wheel. The shift actuator is arranged on the gear wheel of the second gear. In this configuration, the two shift positions can be realised with a short stroke, and the shift actuator can be simplified in that the stroke thereof is reduced and the second spring can be omitted. The advantages of this configuration correspond to those of the configuration according to FIG. 5, the range being smaller.

### LIST OF REFERENCE NUMERALS

1 electric motor

2 two-speed transmission

3 transmission housing

4 drive shaft

5 gear wheel

6 gear wheel

7 shaft or driven shaft

8 gear wheel

8a toothed ring

9 gear wheel

9a toothed ring

10 linear actuator

11 shift sleeve

11a toothed ring

11b toothed ring

12 actuating means

13 magnetic means

14 spring

15 disc

16 step sleeve

20 linear actuator

21 shift sleeve

21a toothed ring

21b toothed ring

22 catch

22a guide bolt

23 magnetic means

27 shaft

30 linear actuator

31 actuator element

32 magnetic means

33 shaft

34 actuator element

34a catch or driver

35 spring

36 shift sleeve

36a bearing bush

47 shaft

48 driver

48a pin

51 electric motor

53 external rotor

54 motor shaft

55 connection

56 gear shaft

58 transmission housing

59 electronics housing

60 driven wheel

61 partition wall

62 passage

63 passage

65 transmission stage

70 driven wheel

71 electric motor

74 motor shaft

77 first stage

78 transmission housing

78a housing cover

79 chain or belt

81 gear wheel

82 gear wheel

82a free-wheel

83 gear wheel

84 gear wheel

85 gear wheel

86 gear wheel

88 actuator

91 gear wheel

92 gear wheel

92a free-wheel

93 gear wheel

94 gear wheel

101 motor

102a shaft

102 motor

102a shaft

103 pinion

104 chain or belt

105 pinion

106 input shaft transmission

107 output shaft transmission

108 housing

109 free-wheel

1. An electric drive system for a battery-powered light vehicle, comprising:
at least one drive motor,
a transmission driven by the drive motor, configured to shift at least two gears, and comprising an actuator configured to actuate the transmission into gear-shift positions, and
an automated transmission with a free-wheel, including an electronic means configured to activate the actuator and to carry out a synchronisation by means of the drive motor upon initiation of a gear-shift procedure.

2. The drive system according to claim 1, wherein the actuator comprises a magnetically actuatable linear shift actuator which has two shift positions (active/neutral) or three shift positions (active left/neutral/active right).

3. The drive system according to claim 1, further comprising a two-stage spring means configured to realise the gear-shift positions.

4. The drive system according to claim 1, wherein the actuator is arranged substantially radially outside a region of gear wheels and includes a catch or driver configured to shift the transmission, wherein the catch or driver is configured to engage in a shift sleeve which is arranged in an axially displaceable manner on a transmission driven shaft.

5. The drive system according to claim 1, wherein the actuator is arranged substantially between driven gear wheels and includes a shift sleeve which is arranged in an axially displaceable manner on a transmission driven shaft.

6. The drive system according to claim 1, further comprising a shift sleeve arranged with two toothed rings in a non-rotatable manner on a transmission driven shaft, non-rotatable arrangement of the shift sleeve being effected by means of a non-rotatably arranged transfer device which has radially offset transfer elements with respect to the transfer shaft.

7. The drive system according to claim 1, wherein the drive motor and transmission form an integrated unit which is arranged in a common housing.

8. The drive system according to claim 7, wherein the common housing includes, on a motor side, a housing accommodating electronics.

9. The drive system according to claim 1, wherein the drive motor is equipped with an oil cooling circuit.

10. The drive system according to claim 1, wherein the actuator is configured to be activated only in a controlled manner, and is controlled using pulse width modulation (PWM).

11. The drive system according to claim 1, wherein, in the case of a two-speed transmission, the free-wheel is arranged on a driven gear wheel of a first gear, and wherein the actuator is arranged on a drive gear wheel of a second gear.

12. The drive system according to claim 1, wherein, in the case of a three-speed transmission, the free-wheel is arranged on a driven gear wheel of a first gear, and wherein the actuator is arranged between driven gear wheel of second and third gears.

13. The drive system according to claim 1, further comprising a gear transmission ratio, implemented using a belt or chain, provided upstream of an input into the transmission, wherein the transmission is arranged parallel to the drive motor.

14. The drive system according to claim 1, further comprising a gear transmission ratio, implemented using a belt or chain, is provided at an output of the transmission.

15. The drive system according to claim 1, wherein a wheel to be driven is driven directly by a transmission driven shaft.

16. The drive system according to claim 1, wherein two motors act on a transmission input, one of the two motors being connected to the transmission by a free-wheel.
